(19) United States
(12) Patent Application Publication
(10) Pub. No.: US 2025/0292374 A1
(43) Pub. Date: Sep. 18, 2025

(54) METHOD OF GENERATING LEARNING MODEL, INFORMATION PROCESSING METHOD, RECORDING MEDIUM, AND INFORMATION PROCESSING DEVICE

(71) Applicant: TOKYO ELECTRON LIMITED, Tokyo (JP)

(72) Inventor: Yuki SATO, Sapporo City (JP)

(73) Assignee: TOKYO ELECTRON LIMITED, Tokyo (JP)

(21) Appl. No.: 19/223,287

(22) Filed: May 30, 2025

Related U.S. Application Data
(63) Continuation of application No. PCT/JP2023/041984, filed on Nov. 22, 2023.

(30) Foreign Application Priority Data
Nov. 30, 2022 (JP) 2022-191965

(51) Int. Cl. G06T 5/60; G06T 5/70; G06T 7/00

(52) U.S. Cl. CPC G06T 5/60; G06T 5/70; G06T 7/001; G06T 2207/10061; G06T 2207/20084; G06T 2207/30148

(57) ABSTRACT

In the method of generating the learning model according to this embodiment, an information processing device acquires a plurality of images of a target substrate captured in chronological order, generates training data in which one image as input among two images selected from the plurality of acquired images and the other image as output are associated with each other, and generates a learning model configured to receive an image obtained by capturing a target substrate as input and output an image from which noise of the image has been removed by machine learning using the training data. It is preferable that the plurality of images includes images under different conditions, and that the two images associated as input and output in the training data are images under the same conditions.

### CROSS-REFERENCE TO RELATED APPLICATIONS

This application is a bypass continuation application of international application No. PCT/JP2023/041984 having an international filing date of Nov. 22, 2023 and designating the United States, the international application being based upon and claiming the benefit of priority from Japanese Patent Applications No. 2022-191965, filed on Nov. 30, 2022, the entire contents of each are incorporated herein by reference.

### TECHNICAL FIELD

The present disclosure relates to a method of generating a learning model, an information processing method, a recording medium, and an information processing device.

### BACKGROUND

Japanese Patent Application Laid-Open No. 2014-81220 proposes a pattern inspection and measurement device that inspects or measures a target pattern using a position of an edge extracted from image data obtained by capturing the target pattern using an edge extraction parameter. This pattern inspection and measurement device generates the edge extraction parameter using image data and a reference pattern representing a shape serving as a reference for inspection or measurement.

### SUMMARY

In a method of generating a learning model according to an embodiment, an information processing device acquires a plurality of images of a target substrate captured in chronological order, generates training data in which one image as input among two images selected from the plurality of acquired images and the other image as output are associated with each other, and generates a learning model configured to receive an image obtained by capturing a target substrate as input and output an image from which noise of the image has been removed by machine learning using the training data.

### BRIEF DESCRIPTION OF DRAWINGS

FIG. 1 is a schematic diagram for describing an overview of an information processing system according to this embodiment.

FIG. 2 is a block diagram illustrating a configuration example of an information processing device according to this embodiment.

FIG. 3 is a schematic diagram illustrating a configuration example of a learning model according to this embodiment.

FIG. 4 is a flowchart illustrating an example of a procedure of a capturing process for data collection performed by a substrate inspection device according to this embodiment.

FIG. 5 is a flowchart illustrating an example of a predetermined procedure of data collection and learning model generation performed by the information processing device according to this embodiment.

FIG. 6 is a schematic diagram for describing an example of a position shift correction process performed by a training data generation unit.

FIG. 7 is a schematic diagram for describing an example of an image pair generation process.

FIG. 8 is a flowchart illustrating an example of a procedure of a measurement and inspection process performed by the information processing device according to this embodiment.

FIG. 9 is a schematic diagram illustrating an example of noise removal by the information processing system according to this embodiment.

### DETAILED DESCRIPTION

Specific examples of an information processing system according to an embodiment of the disclosure will be described below with reference to the drawings. Note that the disclosure is not limited to these examples, is defined by the claims, and is intended to encompass all modifications within the meaning and scope of the claims.

### <System Overview>

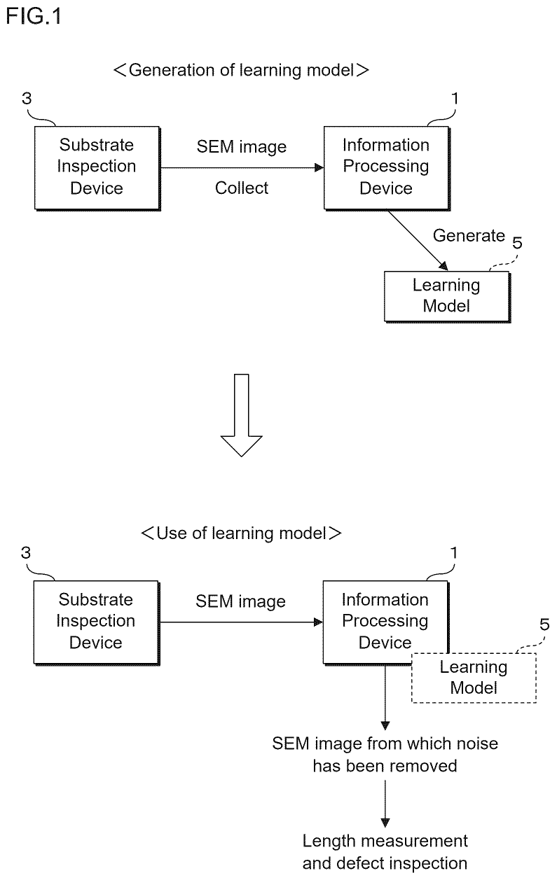

FIG. 1 is a schematic diagram for describing an overview of the information processing system according to this embodiment. The information processing system according to this embodiment includes an information processing device 1 and a substrate inspection device 3. The substrate inspection device 3 according to this embodiment has a capturing function such as an SEM (Scanning Electron Microscope) or a TEM (Transmission Electron Microscope) for capturing a wafer (substrate) which is an inspection target. For example, the substrate inspection device 3 is a device that captures a wafer and acquires a captured image in order to inspect the wafer to be processed by a device such as a substrate processing device that performs processing such as etching on a wafer of a semiconductor.

The information processing device 1 is a device that performs processing related to control, monitoring, etc. of an operation of the substrate inspection device 3. The information processing device 1 according to this embodiment performs processing to collect an SEM image of a wafer captured by the substrate inspection device 3 and generate a learning model 5 by performing machine learning using a plurality of collected SEM images. The learning model 5 is a learning model that receives an SEM image captured by the substrate inspection device 3 as input and outputs an SEM image obtained by removing noise from this input image.

In addition, the information processing device 1 uses the generated learning model 5 to perform processing such as length measurement and defect inspection for a formation on the wafer. That is, the information processing device 1 acquires an SEM image of the wafer captured by the substrate inspection device 3, and inputs the acquired SEM image to the learning model 5. The information processing device 1 acquires an SEM image, from which noise has been removed, output by the learning model 5, and performs processing such as length measurement and inspection based on the acquired SEM image. In this way, the information processing device 1 can perform processing such as length measurement and inspection using the SEM image of the wafer from which noise has been removed, and thus it can be expected that accuracy of processing such as length measurement and inspection is improved when compared to the case of using an SEM image not subjected noise removal. Note that processing such as length measurement and defect inspection of the wafer using the learning model 5 may be performed by the substrate inspection device 3 instead of the information processing device 1.

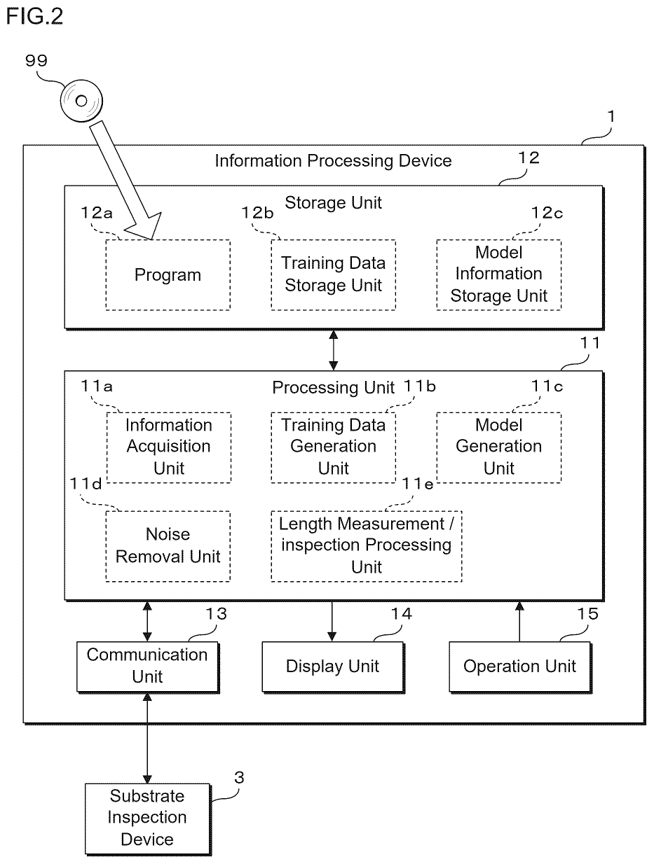

FIG. 2 is a block diagram illustrating a configuration example of the information processing device 1 according to this embodiment. For example, the information processing device 1 according to this embodiment can be realized by installing a predetermined application program, etc. in a general-purpose information processing device such as a personal computer or a server computer. The information processing device 1 includes a processing unit 11, a storage unit 12, a communication unit 13, a display unit 14, an operation unit 15, etc. Note that, even though this embodiment will be described assuming that processing is performed by one information processing device 1, processing of the information processing device 1 may be performed by a plurality of devices in a distributed manner.

The processing unit 11 is configured using an arithmetic processing device such as a CPU (Central Processing Unit), an MPU (Micro-Processing Unit), a GPU (Graphics Processing Unit) or a quantum processor, a ROM (Read Only Memory), a RAM (Random Access Memory), etc. The processing unit 11 reads and executes a program 12a stored in the storage unit 12, thereby performing various processes such as a process of collecting an SEM image of a wafer captured by the substrate inspection device 3 and generating the learning model 5, and a process of removing noise from the SEM image using the generated learning model 5.

For example, the storage unit 12 is configured using a large-capacity storage device such as a hard disk. The storage unit 12 stores various programs executed by the processing unit 11 and various data required for processing of the processing unit 11. In this embodiment, the storage unit 12 stores the program 12a executed by the processing unit 11. In addition, the storage unit 12 includes a training data storage unit 12b that stores training data used in machine learning to generate the learning model 5, and a model information storage unit 12c that stores information related to the generated learning model 5.

In this embodiment, the program (computer program, program product) 12a is provided in a form recorded on a recording medium 99 such as a memory card or an optical disc, and the information processing device 1 reads the program 12a from the recording medium 99 and stores the program 12a in the storage unit 12. However, the program 12a may be written to the storage unit 12, for example, during a manufacturing stage of the information processing device 1. Furthermore, for example, the program 12a may be distributed by a remote server device, etc. and acquired by the information processing device 1 through communication. For example, the program 12a recorded on the recording medium 99 may be read by a writing device and written to the storage unit 12 of the information processing device 1. The program 12a may be provided in the form of distribution via a network or in the form of being recorded on the recording medium 99.

The training data storage unit 12b stores training data generated based on the SEM image of the wafer acquired and collected from the substrate inspection device 3. Even though details will be described later, the learning model 5 according to this embodiment is configured to receive an SEM image as input and output an SEM image from which noise has been removed. The training data used for machine learning of the learning model 5 is data in which two SEM images, namely, an SEM image corresponding to input to the learning model 5 and an SEM image corresponding to output of the learning model 5, are associated with each other. In this embodiment, the information processing device 1 performs capturing a plurality of times using the substrate inspection device 3 on one inspection target. The information processing device 1 selects two SEM images from a plurality of SEM images obtained by capturing, generates, as training data, data in which the two SEM images are associated with each other with one as input and the other one as output, and stores the data in the training data storage unit 12b.

Note that, in this embodiment, the information processing device 1 collects SEM images of various targets captured under various conditions, generates a large amount of training data based on a plurality of SEM images captured under various conditions, and stores and accumulates the generated training data in the training data storage unit 12b. For example, irregularities corresponding to a circuit element, a wire, etc. included in a semiconductor circuit is formed on a surface of a wafer serving as an inspection target of the substrate inspection device 3. In this embodiment, the SEM images collected by the information processing device 1 for training data preferably include various patterns of shapes of the irregularities formed on the wafer.

Furthermore, when a TEM image, etc. obtained by capturing the wafer is used as training data, images collected by the information processing device 1 may include, for example, an image of an internal shape or a cross-sectional shape of the wafer. In this case, it is preferable that the information processing device 1 includes various patterns of boundary information of a plurality of films included in a wafer formation. In this embodiment, it is preferable that the information processing device 1 generates training data by collecting images including various patterns of a structure of the wafer formation.

In addition, an SEM image is an image obtained by capturing a surface of the wafer by scanning with an electron beam, and an SEM image obtained by capturing by the substrate inspection device 3 may include an image obtained by accumulating (averaging) results of a plurality of times of capturing (electron beam scanning). In this embodiment, SEM images collected by the information processing device 1 for training data preferably include images having various cumulative numbers. In addition, the collected SEM images preferably include images captured at various scanning speeds or images captured at various resolutions. The information processing device 1 according to this embodiment can be expected to generate the learning model 5 that accurately removes noise from SEM images by collecting SEM images captured under various conditions to generate training data.

The model information storage unit 12c stores information related to the learning model 5 generated by the information processing device 1 through machine learning. The learning model 5 according to this embodiment may be a learning model having a configuration such as a DNN (Deep Neural Network), a CNN (Convolutional Neural Network), an FCN (Fully Convolution Network), or a U-Net. The information related to the learning model 5 stored in the model information storage unit 12c may include, for example, configuration information indicating a configuration of the learning model, and information such as values of parameters inside the learning model.

The communication unit 13 is connected to the substrate inspection device 3 via a cable such as a communication line or a signal line, and transmits and receives data to and from the substrate inspection device 3 via this cable. In this embodiment, the communication unit 13 receives data of the SEM image of the wafer transmitted from the substrate inspection device 3, and provides the received data to the processing unit 11.

The display unit 14 is configured using a liquid crystal display, etc., and displays various images, characters, etc. based on processing of the processing unit 11. In this embodiment, the display unit 14 displays, for example, the SEM image of the wafer acquired from the substrate inspection device 3, and displays results of measurement and inspection based on the SEM image.

The operation unit 15 receives an operation of a user and notifies the processing unit 11 of the received operation. For example, the operation unit 15 receives an operation of the user through input devices such as mechanical buttons or a touch panel provided on a surface of the display unit 14. In addition, for example, the operation unit 15 may be input devices such as a mouse and a keyboard, and these input devices may be configured to be detachable from the information processing device 1.

Note that the storage unit 12 may be an external storage device connected to the information processing device 1. In addition, the information processing device 1 may be a multi-computer including a plurality of computers, or may be a virtual machine virtually constructed by software. In addition, the information processing device 1 is not limited to the above configuration, and does not have to include, for example, the display unit 14, the operation unit 15, etc.

In addition, in the information processing device 1 according to this embodiment, the processing unit 11 reads and executes the program 12a stored in a memory unit 12, so that an information acquisition unit 11a, a training data generation unit 11b, a model generation unit 11c, a noise removal unit 11d, a length measurement/inspection processing unit 11e, etc. are realized in the processing unit 11 as software functional units.

The information acquisition unit 11a performs a process of acquiring an SEM image of the inspection target wafer captured by the substrate inspection device 3 by communicating with the substrate inspection device 3 via the communication unit 13. In addition, the information acquisition unit 11a acquires, together with the SEM image, information related to capturing conditions when the SEM image is captured, such as the cumulative number, a scanning speed, and resolution, from the substrate inspection device 3. The information acquisition unit 11a stores the SEM image acquired from the substrate inspection device 3 and information related to the capturing conditions in the memory unit 12 in association with each other.

In addition, in this embodiment, when an SEM image is acquired to generate training data to be used for machine learning of the learning model 5, the information acquisition unit 11a acquires a plurality of SEM images obtained by capturing the same inspection target object a plurality of times in chronological order from the substrate inspection device 3. The information acquisition unit 11a stores the plurality of SEM images in the storage unit 12 in association with conditions related to the capturing conditions. Note that, when the same inspection target object is captured a plurality of times, the capturing conditions are the same. When an inspection target object different from this inspection target object is captured, the capturing conditions may be changed. It is preferable that an SEM image collected by the information acquisition unit 11a to generate training data includes images captured under various capturing conditions.

In addition, in this embodiment, when an SEM image is acquired to perform length measurement, inspection, etc. on the inspection target wafer, the information acquisition unit 11a may acquire one SEM image obtained by capturing the inspection target object at least once. However, in this case, the information acquisition unit 11a may acquire a plurality of SEM images obtained by a plurality of times of capturing. Further, in this case, the information acquisition unit 11a may or does not have to acquire information related to capturing conditions together with the SEM images.

The training data generation unit 11b performs processing of generating training data (teacher data) for performing machine learning that generates the learning model 5 based on the plurality of SEM images acquired by the information acquisition unit 11a. As described above, in this embodiment, the information acquisition unit 11a acquires a plurality of SEM images obtained by capturing the same inspection target object a plurality of times in chronological order. The training data generation unit 11b appropriately extracts two SEM images from the plurality of SEM images. The training data generation unit 11b generates data in which one of two extracted SEM images used as an input image (source image) to the learning model 5 and the other SEM image used as an output image (target image, ground truth value) of the learning model are associated with each other. The training data generation unit 11b stores the generated data in the training data storage unit 12b as training data.

In addition, the training data generation unit 11b may perform a process of correcting shift of a capturing position of an inspection target object for a plurality of SEM images obtained by capturing the same inspection target object a plurality of times in chronological order. For example, the training data generation unit 11b can specify a position where the inspection target object is captured in the plurality of SEM images, cut out an image region of a predetermined size where the inspection target object is captured from each SEM image, and use an image obtained by cutting out as a corrected SEM image. The training data generation unit 11b generates training data based on the image after correction.

The model generation unit 11c performs a process of generating the learning model 5 by performing processing of machine learning using training data stored in the training data storage unit 12b. In this embodiment, the learning model 5 is a learning model that receives input of an SEM image, generates an SEM image obtained by removing noise from the input SEM image, and outputs the SEM image. In this embodiment, machine learning performed by the model generation unit 11c to generate the learning model 5 is machine learning that employs a technique of Noise2Noise. In Noise2Noise machine learning, a learning model that converts an image containing noise into an image from which noise has been removed can be generated by training a learning model using conversion from an image containing noise to an image containing noise. Since Noise2Noise machine learning is an existing technology, a detailed description is omitted in this embodiment.

In this embodiment, the SEM image acquired from the substrate inspection device 3 is an image containing noise, and a plurality of SEM images obtained by performing capturing a plurality of times in chronological order are all images containing noise. As described above, the training data generation unit 11b generates training data by extracting and associating two images from the plurality of SEM images, and therefore the two SEM images included in the training data are both images containing noise. The model generation unit 11c can perform so-called supervised machine learning using one SEM image included in the training data as an input image to the learning model 5 and the other SEM image as a ground truth value for an output image of the learning model 5, thereby determining internal parameters of the learning model 5 and generating the learning model 5. The model generation unit 11c stores information related to the generated learning model 5 in the model information storage unit 12c.

The noise removal unit 11d uses the learning model 5 previously generated by machine learning to perform a process of removing noise from the SEM image acquired from the substrate inspection device 3. The noise removal unit 11d reproduces the machine-trained learning model 5 based on information stored in the model information storage unit 12c. The noise removal unit 11d inputs the SEM image of the inspection target wafer acquired by the information acquisition unit 11a from the substrate inspection device 3 to the learning model 5, and acquires the SEM image output by the learning model 5, thereby removing noise from the SEM image.

The length measurement/inspection processing unit 11e performs processing such as length measurement and inspection on the inspection target wafer captured in the SEM image based on the SEM image from which noise has been removed by the noise removal unit 11d. For example, the length measurement/inspection processing unit 11e performs image processing such as edge detection on the SEM image, thereby recognizing a pattern of an irregularity shape on a surface, a cross section, etc. of the wafer captured in the SEM image. For example, the length measurement/inspection processing unit 11e can perform length measurement by measuring a distance between two predetermined corners included in the pattern of the irregularity shape. In addition, for example, the length measurement/inspection processing unit 11e can inspect the presence or absence of defects in the inspection target wafer by verifying whether the pattern of the irregularity shape matches a predetermined pattern, or whether a length measurement result is within a predetermined range. The length measurement/inspection processing unit 11e displays the length measurement result, an inspection result, etc. on the display unit 14.

Note that these processes performed by the length measurement/inspection processing unit 11e are merely examples and are not limited thereto. The length measurement/inspection processing unit 11e may perform length measurement using any method and may perform inspection using any method. The information processing device 1 may be configured to perform only one of length measurement and inspection based on an SEM image and not to perform the other one. In addition, the information processing device 1 may perform processes up to a process of removing noise from the SEM image, and processes such as length measurement and inspection based on the SEM image from which noise has been removed may be performed by another device.

### <Generation of Learning Model>

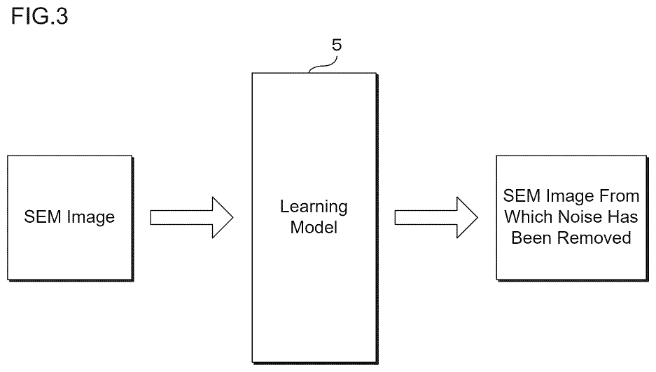

FIG. 3 is a schematic diagram illustrating a configuration example of the learning model 5 according to this embodiment. For example, the learning model 5 according to this embodiment is configured as a DNN or a CNN, receives an SEM image of a predetermined size as input, and outputs an SEM image of a predetermined size. The SEM image output by the learning model 5 is an SEM image obtained by removing noise from the input SEM image. By using the learning model 5, the information processing device 1 can perform processes such as length measurement and inspection on the wafer processed by the substrate inspection device 3 with high accuracy based on the SEM image captured by the substrate inspection device 3. Before performing processes such as length measurement and inspection, the information processing device 1 performs a process of collecting the SEM image captured by the substrate inspection device 3 and generating the learning model 5 by machine learning using the collected SEM image.

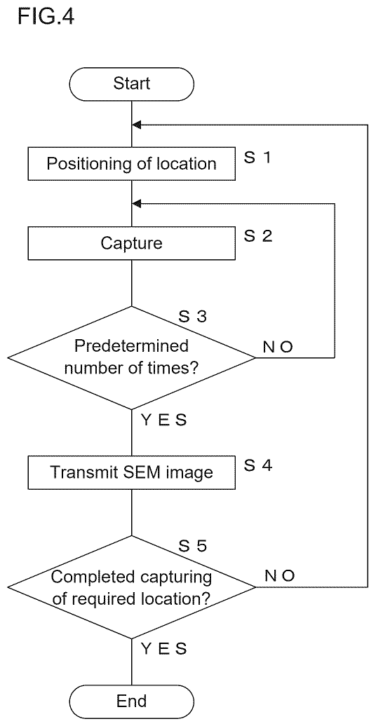

FIG. 4 is a flowchart illustrating an example of a procedure of a capturing process for data collection performed by the substrate inspection device 3 according to this embodiment. For example, the substrate inspection device 3 according to this embodiment performs a process of capturing the wafer for data collection according to the control from the information processing device 1. The substrate inspection device 3 performs positioning of a location to be captured for the wafer to be captured (step S1). The substrate inspection device 3 captures an SEM image by scanning, with an electron beam, a target location of the wafer where a capturing position has been determined (step S2). For example, the substrate inspection device 3 determines whether or not a predetermined number of SEM images designated by the information processing device 1 have been captured (step S3). When capturing has not been performed the predetermined number of times (S3: NO), the substrate inspection device 3 returns the process to step S2 and repeatedly captures the same location of the wafer.

When capturing has been performed the predetermined number of times (S3: YES), the substrate inspection device 3 transmits the predetermined number of captured SEM images to the information processing device 1 (step S4). In this instance, the substrate inspection device 3 may transmit information such as a capturing condition to the information processing device 1 together with the plurality of SEM images. The substrate inspection device 3 determines whether or not capturing of all locations requiring capturing for the inspection target wafer has been completed (step S5). When capturing of all required locations has not been completed (S5: NO), the substrate inspection device 3 returns the process to step S1, performs positioning of another location on the wafer, and captures an SEM image. When capturing of all required locations has been completed (S5: YES), the substrate inspection device 3 ends the process.

Note that the number of times that the substrate inspection device 3 captures one location (the predetermined number determined in step S3) does not have to be constant. For example, capturing may be performed a different number of times for each capturing location. In this case, the number of times of capturing at each location may be determined by the substrate inspection device 3 or may be determined by the user. For example, the substrate inspection device 3 may randomly determine the number of times of capturing. In addition, for example, the amount of noise, clarity, etc. may be evaluated for one captured image to determine the number of times of capturing according to an evaluation result, and the number of times of capturing may be determined using other methods. In addition, for example, the substrate inspection device 3 may receive input of the number of times of capturing from the user for each capturing location. In addition, for example, the substrate inspection device 3 may determine the number of times of capturing based on setting of the number of times of capturing performed in advance by the user.

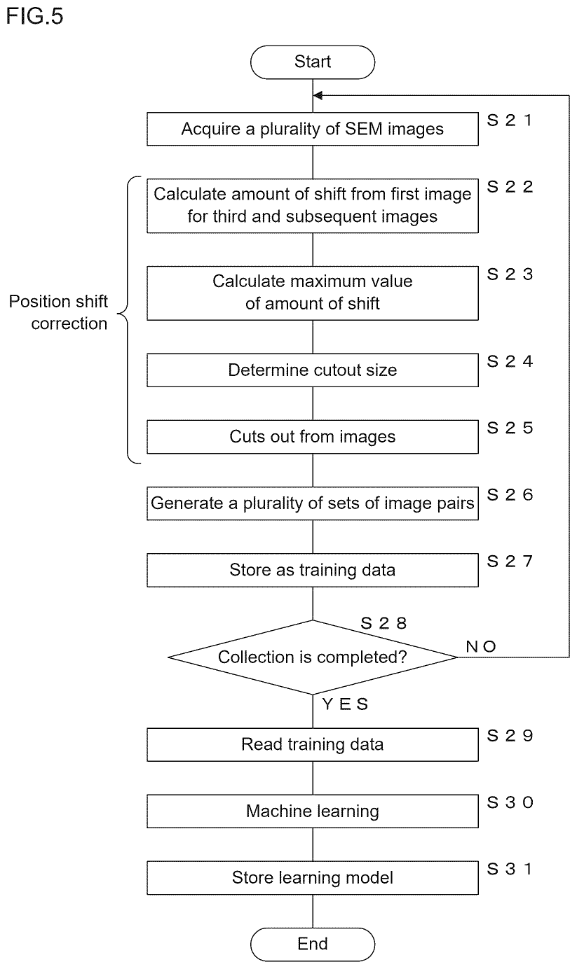

FIG. 5 is a flowchart illustrating an example of a predetermined procedure of data collection and learning model generation performed by the information processing device 1 according to this embodiment. The information acquisition unit 11a of the processing unit 11 of the information processing device 1 according to this embodiment communicates with the substrate inspection device 3 via the communication unit 13, so that the information acquisition unit 11a acquires a plurality of SEM images obtained by the substrate inspection device 3 capturing the same location of the wafer a plurality of times (step S21).

Next, the training data generation unit 11b of the processing unit 11 performs a position shift correction process of correcting shift of a position where a target location is captured between images for the plurality of SEM images acquired in step S21 (steps S22 to S25).

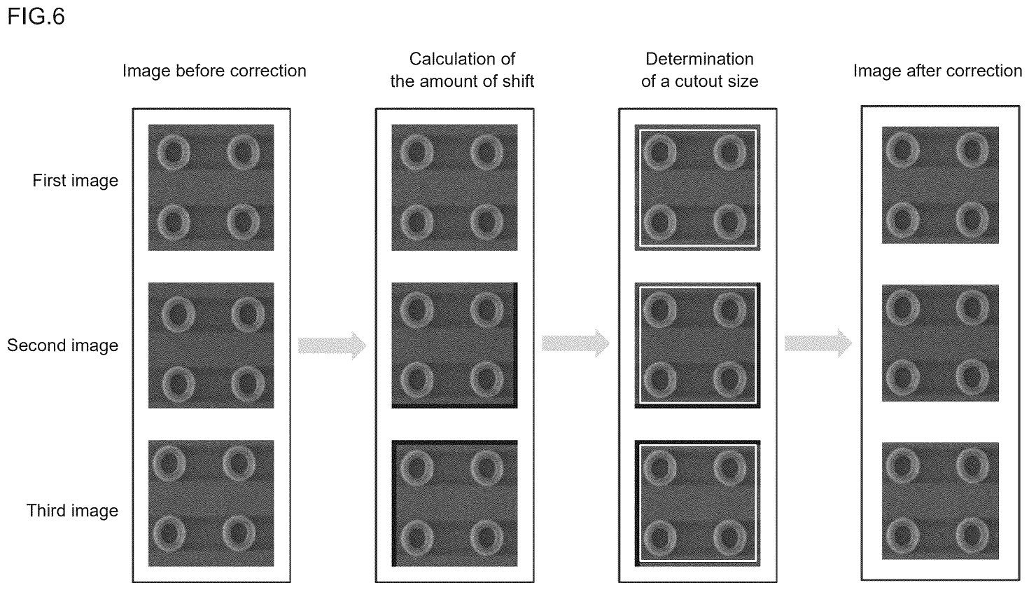

FIG. 6 is a schematic diagram for describing an example of a position shift correction process performed by the training data generation unit 11b. FIG. 6 illustrates a plurality of SEM images (first image to third image) obtained by capturing the same location of the wafer arranged in a vertical direction. In addition, FIG. 6 illustrates results of processes on each SEM image in a horizontal direction arranged in order of an image before correction→calculation of the amount of shift→determination of a cutout size→an image after correction in times series from the left to the right. Each image illustrated in FIG. 6 is an SEM image obtained by capturing a part of the inspection target wafer, for example, a part where four annular formations are arranged vertically and horizontally.

The substrate inspection device 3 obtains an SEM image by focusing an electron beam on the inspection target wafer to radiate the electron beam and scanning the wafer with the electron beam. For this reason, even when the same location is continuously captured with the wafer fixed, a position of the inspection target object captured in the captured image may be shifted due to an error in a scanning position of the electron beam. The information processing device 1 of this embodiment is expected to correct positional shift of the plurality of SEM images in advance and generate training data based on the corrected SEM images, thereby improving accuracy of noise removal of the learning model 5 generated by machine learning using this training data.

The training data generation unit 11b uses, for example, a first SEM image as a base image, and calculates the amount of shift of the position of the inspection target object captured in the image between this base image and each image from a second image onwards. In this instance, for example, the training data generation unit 11b moves the second image up, down, left, and right relative to a reference image to search for a position where inspection target objects in both images match. In the example illustrated in FIG. 6, inspection target objects in the reference image and the second image match by moving the second image by a few pixels to the upper left. The training data generation unit 11b calculates the amount (number of pixels) by which the second image is moved from an original position at this time as the amount of shift from the reference image. In the example illustrated in FIG. 6, the amount of shift of the second image is a few pixels to the right side and a few pixels to the lower side, and in this figure, this amount of shift is illustrated as a black region on the right side and the lower side of the second image.

The training data generation unit 11b similarly calculates the amount of shift from the reference image for a third and subsequent images. In the example illustrated in FIG. 6, the amount of shift of the third image is a few pixels to the upper side and a few pixels to the left side. The training data generation unit 11b calculates the amount of shift from the reference image in each of the four directions, up, down, left, and right, from the second image to the last image (step S22). Thereafter, the training data generation unit 11b calculates a maximum value of the amount of shift for each direction based on a plurality of amounts of shift calculated for the respective four directions, up, down, left, and right (step S23).

Next, the training data generation unit 11b determines a size of an image region to be cut out from each of the plurality of images based on the calculated maximum value of the amount of shift calculated in the four directions, up, down, left, and right. The training data generation unit 11b sets, as a cutout size, a size reduced from a size of the original image by a size of the calculated maximum value of the amount of shift calculated in each of the directions, up, down, left, and right (step S24). In the example illustrated in FIG. 6, the cutout size for each image is displayed by overlapping a rectangular frame.

Next, the training data generation unit 11b cuts out an image region of a determined cutout size from the first image (reference image). In addition, for the second and subsequent images, the training data generation unit 11b cuts out the image region of the determined cutout size from an image after positioning with respect to the reference image (the image of “calculation of the amount of shift” of FIG. 6). In this way, the training data generation unit 11b cuts out the image region of the determined cutout size from each of the plurality of images (step S25), and sets the plurality of cutout images as images after correction. Note that the shift correction method illustrated in FIG. 6 is an example and is not limited thereto, and the information processing device 1 may correct shift using any method.

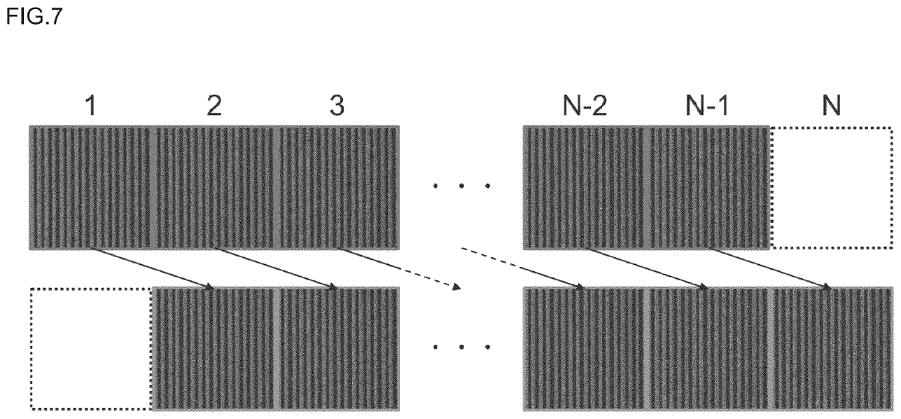

Next, the training data generation unit 11b generates a plurality of sets of image pairs based on the plurality of SEM images whose positional shifts have been corrected (step S26). FIG. 7 is a schematic diagram for describing an example of an image pair generation process. In the example illustrated in FIG. 7, N SEM images are arranged in the horizontal direction from the first image to the Nth image, and the same images are arranged in two rows, one above the other. However, in the upper row of FIG. 7, the Nth image is omitted as a dashed frame, and in the lower row of FIG. 7, the first image is omitted as a dashed frame. In addition, each image illustrated in FIG. 7 is an SEM image obtained by capturing a part of the inspection target wafer, for example, a part where a plurality of linear formations extending in the vertical direction is arranged in the horizontal direction.

The training data generation unit 11b generates (N−1) sets of image pairs by pairing the first image and the second image, the second image and the third image, . . . , the (N−1)th image and the Nth image. That is, the training data generation unit 11b generates (N−1) sets of image pairs by pairing two images, namely, an image at a certain time point and an image at the next time point, from N SEM images obtained by capturing the same location in chronological order. The training data generation unit 11b stores data in which one of the two images of the generated image pair set as an input image to the learning model 5 and the other one set as an output image of the learning model 5 are associated with each other in the training data storage unit 12b as training data (step S27).

The training data generation unit 11b determines whether or not collection of training data is completed (step S28) depending on whether a sufficient amount of training data has been accumulated to generate the learning model 5. When collection of training data is not completed (S28: NO), the training data generation unit 11b returns the process to step S21, acquires a plurality of SEM images obtained by capturing another location of the same wafer or another wafer by the substrate inspection device 3, and repeats the above-mentioned process. Note that, in this embodiment, the number of the plurality of SEM images obtained by capturing the same location by the substrate inspection device 3 may be different for each capturing location. For this reason, the number of SEM images acquired by the training data generation unit 11b in step S21 may be different for each loop of steps S21 to S28.

When collection of training data is completed (S28: YES), the model generation unit 11c of the processing unit 11 reads a plurality of pieces of training data stored in the training data storage unit 12b (step S29). The model generation unit 11c uses the training data read in step S29 to perform so-called supervised machine learning (step S30) by using one of a pair of two SEM images included in the training data as an input image to the learning model 5 and the other one as (a ground truth value of) an output image of the learning model 5, thereby generating the learning model 5. The model generation unit 11c stores information related to the learning model 5 generated by machine learning of step S30 in the model information storage unit 12c (step S31), and ends the process.

### <Use of Learning Model>

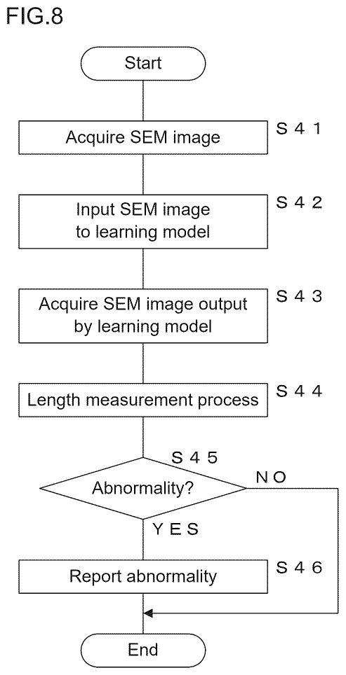

FIG. 8 is a flowchart illustrating an example of a procedure of a measurement and inspection process performed by the information processing device 1 according to this embodiment. In the information processing system according to this embodiment, for example, various processes are performed on a wafer in the substrate processing device, and the wafer is captured by the substrate inspection device 3 during these processes or after completion of the processes. The information acquisition unit 11a of the processing unit 11 of the information processing device 1 acquires an SEM image of the wafer captured by the substrate inspection device 3 by communicating with the substrate inspection device 3 via the communication unit 13 (step S41).

The noise removal unit 11d of the processing unit 11 reads information stored in the model information storage unit 12c to construct the learning model 5, and inputs the SEM image acquired in step S41 to the learning model 5 (step S42). The noise removal unit 11d acquires the SEM image (the SEM image from which noise has been removed) output by the learning model 5 in response to input of the SEM image of step S42 (step S43).

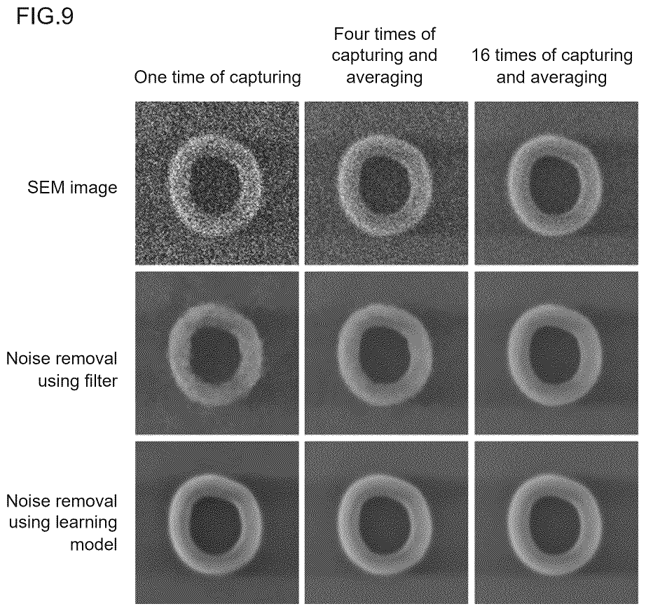

FIG. 9 is a schematic diagram illustrating an example of noise removal by the information processing system according to this embodiment. In FIG. 9, nine SEM images are arranged in a 3×3 matrix. Three SEM images in an upper row are SEM images acquired by the information processing device 1 from the substrate inspection device 3. An SEM image, which is obtained by one time of capturing, illustrated on the left side of the upper row is an SEM image obtained by the substrate inspection device 3 performing scanning with an electron beam once. An SEM image, which is obtained by four times of capturing and averaging, illustrated in center of the upper row is an SEM image obtained by calculating an average value of four SEM images obtained by the substrate inspection device performing scanning with an electron beam four times. An SEM image, which is obtained by 16 times of capturing and averaging, illustrated in on the right of the upper row is an SEM image obtained by calculating an average value of 16 SEM images obtained by the substrate inspection device performing scanning with an electron beam 16 times. In addition, three SEM images in the middle of FIG. 9 are SEM images obtained by performing image processing using a noise removal filter on the three SEM images in the upper row. Note that the noise removal filter employs a BM3D (Block Matching and 3D collaborative filtering) method, but since noise removal using BM3D is an existing technology, a detailed description will be omitted. Three SEM images in the lower row of FIG. 9 are SEM images obtained by performing noise removal on the three SEM images in the upper row using the learning model 5 according to this embodiment.

When noise removal is performed using a filter based on the SEM image, which is obtained by one time of capturing, illustrated in FIG. 9, the noise cannot be completely removed, and an SEM image in which the inspection target object is unclear is obtained. In contrast, when noise removal is performed using the learning model 5 according to this embodiment based on the SEM image obtained by one time of capturing, noise is largely removed, and an SEM image in which the inspection target object is clearly captured is obtained. In noise removal using the learning model 5, even when the SEM image obtained by one time of capturing is used as a base, noise removal is achieved to the same extent as when the SEM image obtained by 16 times of capturing and averaging is used as a base. In noise removal using a filter, when the SEM image obtained by 16 times of capturing and averaging is used as a base, noise removal can be achieved to the same extent as when the learning model 5 is used. However, 16 times of capturing requires a significant amount of time.

After removing noise from the SEM image in steps S42 and S43, the length measurement/inspection processing unit 11e of the processing unit 11 performs a length measurement process on the formation on the wafer captured in the SEM image (step S44). In the length measurement process, for example, the length measurement/inspection processing unit 11e performs edge detection on the SEM image to detect a shape of irregularities of the formation, and calculates a distance between predetermined locations (for example, corners, etc.) of the irregularities. The length measurement/inspection processing unit 11e calculates an actual distance based on the calculated distance on the SEM image and magnification of the image. In the case of the SEM image illustrated in FIG. 9, for example, the length measurement/inspection processing unit 11e can measure a distance such as a diameter or a circumference of a ring or cylindrical structure.

The length measurement/inspection processing unit 11e determines the presence or absence of an abnormality in the formation on the wafer based on a comparison between a result of length measurement of step S44 and a predetermined threshold value (step S45). When it is determined that there is an abnormality (S45: YES), for example, the length measurement/inspection processing unit 11e reports the abnormality by displaying a warning message on the display unit 14 (step S46), and ends the process. When it is determined that there is no abnormality (S45: NO), the length measurement/inspection processing unit 11e ends the process without reporting the abnormality.

### Summary

In the information processing system according to this embodiment having the above configuration, the information processing device 1 acquires a plurality of SEM images related to an inspection target wafer obtained by being captured in chronological order by the substrate inspection device 3. The information processing device 1 generates training data in which one of two images, which are selected from the plurality of acquired SEM images, set as input and the other SEM image set as output are associated with each other. The information processing device 1 performs machine learning processing using the generated training data, thereby generating the learning model 5 that receives an SEM image obtained by capturing the inspection target wafer as input and outputs an SEM image from which noise of the received image has been removed. In this way, the information processing system can remove noise from the SEM image using the generated learning model 5, and can be expected to improve accuracy of wafer length measurement, inspection, etc. using the SEM image.

Note that, in this embodiment, an SEM image is used as the image acquired from the substrate inspection device 3. However, the disclosure is not limited thereto, and a TEM image or various other images may be adopted.

In the information processing system according to this embodiment, the plurality of SEM images acquired by the information processing device 1 from the substrate inspection device 3 may include images under different conditions. For example, the images under different conditions may include images having different patterns of irregularity shapes formed on the substrate of the inspection target, images having different cumulative numbers, images having different scanning speeds, images having different resolutions, etc. However, the two SEM images associated as input and output in the training data are SEM images under the same conditions. By performing machine learning using the plurality of SEM images under different conditions, it is possible to train the learning model 5 using images under various conditions, and it is possible to expect that accuracy of noise removal by the learning model 5 is improved. Note that the conditions are merely examples and the disclosure is not limited thereto. Further, the plurality of images may include SEM images under various other conditions. For example, when images handled by the information processing system are color images, images under different conditions such as the number of colors, resolution, or the number of gradations for each color such as RGB or CMY may be included.

Furthermore, in the information processing system according to this embodiment, based on the plurality of SEM images captured in chronological order by the substrate inspection device 3, the information processing device 1 generates training data in which one image as input included in the plurality of SEM images and an image as output subsequent to this one image are associated with each other. The information processing device 1 can generate training data by associating, for example, two chronologically consecutive images, with the first image as input and the next image as output. The information processing device 1 can generate a plurality of pieces of training data by extracting a plurality of sets of two consecutive images from a plurality of SEM images. In this way, the information processing device 1 can easily generate training data by associating a plurality of SEM images in chronological order.

A method of generating training data based on a plurality of SEM images is not limited to the above method. For example, the information processing device 1 may generate training data by randomly extracting two images from a plurality of SEM images under the same conditions and appropriately associating the images as input and output. Training data may be generated by setting a later SEM image in chronological order as input of the learning model 5 and an earlier SEM image in chronological order as output (ground truth value).

In addition, in the information processing system according to this embodiment, the information processing device 1 performs a process for correcting a position of an inspection target captured in each SEM image for a plurality of SEM images acquired from the substrate inspection device 3, and generates training data based on the image after correction. For example, the information processing device 1 selects one reference image from the plurality of SEM images, and calculates the amount of positional shift of each image other than the reference image with respect to the reference image. The information processing device 1 can determine a cutout size based on a maximum value of the calculated amount of shift, cut out an image of this size from each image, and use the cutout image as the image after correction. By generating training data by correcting the positional shift in advance, it is possible to expect improvement of accuracy of noise removal by the learning model 5 generated by machine learning using this training data.

In addition, in the information processing system according to this embodiment, the information processing device 1 acquires an SEM image obtained by capturing an inspection target wafer from the substrate inspection device 3, inputs the acquired SEM image to the learned learning model 5, and acquires an SEM image output by the learning model 5. In this way, the information processing device 1 can acquire an SEM image from which noise has been removed by the learning model 5. Based on the acquired SEM image, the information processing device 1 performs length measurement or inspection on the inspection target captured in this SEM image. In this way, the information processing device 1 can perform processing such as length measurement and inspection based on the SEM image from which noise has been removed, and it is possible to expect that accuracy of length measurement, inspection, etc. is improved.

Note that, in this embodiment, the information processing device 1 performs both a process of generating the learning model 5 and a process of using the generated learning model 5. However, the disclosure is not limited thereto. Each of the processes may be performed by a different device, or the processes may be appropriately shared among three or more devices. In addition, the generated learning model 5 may be used by the substrate inspection device 3, and the substrate inspection device may perform a process of removing noise from the SEM image. In addition, a description has been given of an example in which a substrate processed by the substrate processing device and inspected by the substrate inspection device 3 is a semiconductor wafer. However, the substrate is not limited to the semiconductor wafer, and may be various substrates such as a glass substrate. In addition, capturing by the substrate inspection device 3 is not limited to the SEM or the TEM, and may be performed by, for example, a CCD (Charge Coupled Device), etc. In addition, the SEM images of FIGS. 6, 7, and 9 are merely examples, and images handled by the information processing device 1 are not limited to the images given as examples, and may be any images.

### <Modified Examples Related to Generation of Training Data>

In the above-described embodiment, training data is generated by combining two SEM images containing noise based on a plurality of SEM images obtained by capturing the same location a plurality of times. In EUV (Extreme Ultraviolet Lithography) exposure or capturing by the TEM, etc., it may be difficult to capture the same location a plurality of times. The information processing device 1 according to the modified example generates training data based on a plurality of noisy images (images containing noise) obtained by capturing different locations.

The information processing device 1 according to the modified example acquires, from among a plurality of noisy images obtained by capturing, for example, a noisy image A obtained by capturing a location A of a substrate and a noisy image B obtained by capturing a location B. The information processing device 1 performs image processing using an appropriate noise removal filter on the noisy images A and B, respectively, to obtain clean images (images from which noise has been removed) A and B from which noise has been removed from the noisy images A and B. The information processing device 1 performs deconvolution processing using a set of one noisy image B and clean image B, and extracts a noise component B contained in the noisy image B. The information processing device 1 performs convolution processing on the extracted noise component B with respect to the other clean image A, thereby obtaining a noisy image A′.

The original noisy image A and the noisy image A′ obtained by the above processing are images obtained by capturing the same location A of the substrate, but contain different noises. The information processing device 1 can set a combination of these two noisy images A and A′ as training data and use the training data for machine learning of Noise2Noise. In addition, when performing machine learning other than Noise2Noise, for example, a combination of the clean image A and the noisy image A′ may be used as training data.

Note that, in the above example, noise is removed from the noisy image A to generate the clean image A, and the noise component B extracted from the noisy image B is superimposed on the clean image A. However, the disclosure is not limited thereto. For example, an image that can be treated as a clean image having little noise may be acquired at a capturing stage, and the noise component B may be superimposed using this image as the clean image A to generate the noisy image A′. Furthermore, the two images A and B may be images obtained by capturing different substrates, respectively, rather than images obtained by capturing the same substrate. For example, the noisy image A′ may be generated by superimposing the noise component B extracted from the noisy image B obtained by capturing a second substrate onto the clean image A obtained by removing noise from the noisy image A obtained by capturing a first substrate (or the clean image A having little noise at the capturing stage).

The information processing device 1 according to the modified example of the above configuration includes a noise removal unit that removes noise from a noisy image to generate a clean image, a noise component extraction unit that extracts a noise component by deconvolution of the noisy image and the clean image, and a noise superposition unit that superimposes the extracted noise component onto another clean image by convolution. The information processing device 1 acquires two noisy images obtained by capturing different locations, acquires two clean images by the noise removal unit, extracts a noise component based on one noisy image and one clean image, and superimposes the noise component on the other clean image to acquire another noisy image. The information processing device 1 can combine the acquired noisy image with the original noisy image to use this combination as training data, and perform machine learning of Noise2Noise. Alternatively, the information processing device 1 may combine the acquired noisy image with the clean image to use this combination as training data.

Note that a method of generating training data by the information processing device 1 according to the modified example can be applied to SEM images, TEM images, or various other images containing noise.

The embodiments disclosed herein are illustrative in all respects and should not be considered to be restrictive. The scope of the disclosure is defined by the claims, not by the above meaning, and is intended to include all modifications within the scope and meaning equivalent to the claims.

The items described in each embodiment can be combined with each other. In addition, the independent claims and dependent claims described in the claims can be combined with each other in any and all combinations regardless of the citation format. Furthermore, the claims use a format in which a claim cites two or more other claims (multi-claim format). However, the disclosure is not limited thereto. A multi-claim that cites at least one multi-claim (multi-multi claim) may be used.

According to the disclosure, it is possible to expect that noise is accurately removed from an image obtained by capturing a substrate.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

1. A method of generating a learning model, the method being performed by an information processing device, the method comprising:
acquiring a plurality of images of a target substrate captured in chronological order;
generating training data in which one image as input among two images selected from the plurality of acquired images and the other image as output are associated with each other; and
generating a learning model configured to receive an image obtained by capturing a target substrate as input and output an image from which noise of the image has been removed by machine learning using the training data.

2. The method according to claim 1, wherein:
the plurality of images includes images under different conditions, and
the two images associated as the input and the output in the training data are images under the same conditions.

3. The method according to claim 2, wherein the condition includes a pattern of a structure of a formation formed on the target substrate.

4. The method according to claim 2, wherein:
each of the acquired images is an image obtained by accumulating a plurality of capturing results, and
the condition includes a cumulative number of each image.

5. The method according to claim 2, wherein:
the acquired images are images obtained by capturing the target substrate by a scanning electron microscope, and
the condition includes a scanning speed of the scanning electron microscope.

6. The method according to claim 2, wherein the condition includes resolution of an image obtained by capturing.

7. The method according to claim 1, further comprising generating training data in which one image as input included in the plurality of images and an image as output subsequent to the one image in chronological capturing order are associated with each other.

8. The method according to claim 7, further comprising generating a plurality of pieces of training data by extracting a plurality of sets of two chronologically consecutive images from the plurality of images.

9. The method according to claim 1, further comprising:
correcting a position of the target substrate captured in each image for the plurality of acquired images; and
generating the training data based on a plurality of images after correction.

10. The method according to claim 9, further comprising:
selecting one reference image from the plurality of images;
calculating an amount of shift of a position with respect to the reference image for each image other than the reference image;
determining a cutout size based on a maximum value of the calculated amount of shift;
cutting out an image of the size from each image; and
setting the cutout image as an image after correction.

11. The method according to claim 9, wherein the training data is data in which two images each containing noise and subjected to correction to align a position of the captured target substrate are associated as input and output.

12. An information processing method performed by an information processing device, the information processing method comprising:
acquiring an image obtained by capturing a target substrate;
inputting the acquired image to a learning model subjected to machine learning to receive an image obtained by capturing the target substrate as input and output an image from which noise of the image has been removed, and acquiring an image from which noise has been removed output by the learning model; and
outputting the acquired image,
wherein the learning model is generated by machine learning using training data in which one image as input among two images selected from a plurality of images of a target substrate captured in chronological order and the other image as output are associated with each other.

13. The information processing method according to claim 12, further comprising performing length measurement or inspection related to the target substrate based on an image from which noise has been removed.

14. A non-transitory recording medium in which a computer program is recorded, the computer program causing a computer to execute processing of:
acquiring a plurality of images of a target substrate captured in chronological order;
generating training data in which one image as input among two images selected from the plurality of acquired images and the other image as output are associated with each other; and
generating a learning model configured to receive an image obtained by capturing a target substrate as input and output an image from which noise of the image has been removed by machine learning using the training data.

15. A non-transitory recording medium in which a computer program is recorded, the computer program causing a computer to execute processing of:
acquiring an image obtained by capturing a target substrate;
inputting the acquired image to a learning model subjected to machine learning to receive an image obtained by capturing the target substrate as input and output an image from which noise of the image has been removed, and acquiring an image from which noise has been removed output by the learning model; and
outputting the acquired image,
wherein the learning model is generated by machine learning using training data in which one image as input among two images selected from a plurality of images of a target substrate captured in chronological order and the other image as output are associated with each other.

16. An information processing device comprising a processing unit,
wherein the processing unit is configured to:
acquire a plurality of images of a target substrate captured in chronological order,
generate training data in which one image as input among two images selected from the plurality of acquired images and the other image as output are associated with each other, and
generate a learning model configured to receive an image obtained by capturing a target substrate as input and output an image from which noise of the image has been removed by machine learning using the training data.

17. An information processing device comprising a processing unit, wherein:
the processing unit acquires an image obtained by capturing a target substrate, inputs the acquired image to a learning model subjected to machine learning to receive an image obtained by capturing the target substrate as input and output an image from which noise of the image has been removed, acquires an image from which noise has been removed output by the learning model, and outputs the acquired image,
wherein the learning model is generated by machine learning using training data in which one image as input among two images selected from a plurality of images of a target substrate captured in chronological order and the other image as output are associated with each other.
